(19) United States
(12) Patent Application Publication
(10) Pub. No.: US 2006/0004984 A1
(43) Pub. Date: Jan. 5, 2006

(54) Virtual memory management system

(76) Inventors: Tonia G. Morris, Chandler, AZ (US); Eugene P. Matter, Folsom, CA (US); Sean S. Eilert, Penryn, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,360

(22) Filed: Jun. 30, 2004

(51) Int. Cl. G06F 12/08

(52) U.S. Cl. 711/203; 711/154

(57) ABSTRACT

Method and apparatus to perform virtual memory management using a general memory access processor are described.

### BACKGROUND

A virtual memory system may use virtual addresses to represent physical addresses in multiple memory units. An application program may use the virtual addresses to store instructions and data. When a processor executes the program, the virtual addresses may be translated into the corresponding physical addresses to access the instructions and data. Virtual memory systems, however, may introduce some latency in retrieving information from the physical memory due to virtual memory management operations. Consequently, there may be a need to improve a virtual memory system in a device or network.

### BRIEF DESCRIPTION OF THE DRAWINGS

FIG. 1 illustrates a block diagram of a system 100.

FIG. 2 illustrates a block diagram of a system 200.

FIG. 3 illustrates a block diagram of a processing logic 300.

FIG. 4 illustrates a message flow diagram 400.

### DETAILED DESCRIPTION

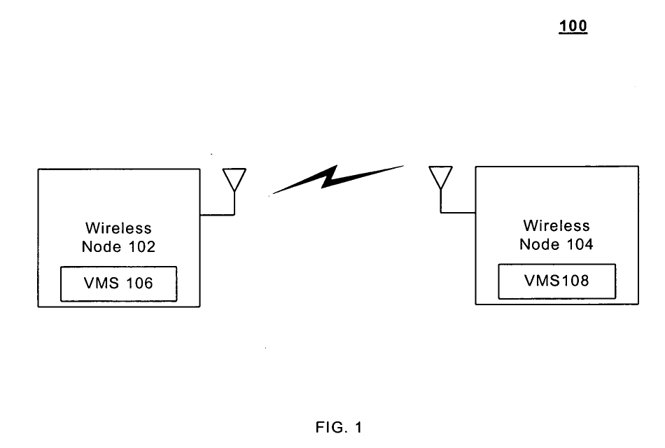

FIG. 1 illustrates a block diagram of a system 100. System 100 may comprise, for example, a communication system to communicate information between multiple nodes. The nodes may comprise any physical or logical entity having a unique address in system 100. The unique address may comprise, for example, a network address such as an Internet Protocol (IP) address, device address such as a Media Access Control (MAC) address, and so forth. The embodiments are not limited in this context.

The nodes may be connected by one or more types of communications media. The communications media may comprise any media capable of carrying information signals, such as metal leads, semiconductor material, twisted-pair wire, co-axial cable, fiber optics, radio frequency (RF) spectrum, and so forth. The connection may comprise, for example, a physical connection or logical connection.

The nodes may be connected to the communications media by one or more input/output (I/O) adapters. The I/O adapters may be configured to operate with any suitable technique for controlling communication signals between computer or network devices using a desired set of communications protocols, services and operating procedures. The I/O adapter may also include the appropriate physical connectors to connect the I/O adapter with a given communications medium. Examples of suitable I/O adapters may include a network interface card (NIC), radio/air interface, and so forth.

The general architecture of system 100 may be implemented as a wired or wireless system. If implemented as a wireless system, one or more nodes shown in system 100 may further comprise additional components and interfaces suitable for communicating information signals over the designated RF spectrum. For example, a node of system 100 may include omni-directional antennas, wireless RF transceivers, control logic, and so forth. The embodiments are not limited in this context.

The nodes of system 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes may communicate the media and control information in accordance with one or more protocols. A protocol may comprise a set of predefined rules or instructions to control how the nodes communicate information between each other. The protocol may be defined by one or more protocol standards, such as the standards promulgated by the Internet Engineering Task Force (IETF), International Telecommunications Union (ITU), the Institute of Electrical and Electronics Engineers (IEEE), and so forth.

Referring again to FIG. 1, system 100 may comprise a node 102 and a node 104. In one embodiment, for example, nodes 102 and 104 may comprise wireless nodes arranged to communicate information over a wireless communication medium, such as RF spectrum. Wireless nodes 102 and 104 may represent a number of different wireless devices, such as a mobile or cellular telephone, a computer equipped with a wireless access card or modem, a handheld client device such as a wireless personal digital assistant (PDA), a wireless access point, a base station, a mobile subscriber center, a radio network controller, and so forth. In one embodiment, for example, nodes 102 and/or 104 may comprise wireless devices developed in accordance with the Personal Internet Client Architecture (PCA) by Intel® Corporation. Although FIG. 1 shows a limited number of nodes, it can be appreciated that any number of nodes may be used in system 100. Further, although the embodiments may be illustrated in the context of a wireless communications system, the principles discussed herein may also be implemented in a wired communications system as well. The embodiments are not limited in this context.

In one embodiment, nodes 102 and node 104 may include virtual memory system (VMS) 106 and VMS 108, respectively. VMS 106 and 108 may use virtual memory to abstract or separate logical memory from physical memory. The logical memory may refer to the memory used by an application program. The physical memory may refer to the memory used by the processor. Because of this separation, an application program may use the logical memory while the operating system (OS) for nodes 102 and 104 may maintain two or more levels of physical memory space. For example, the virtual memory abstraction may be implemented using one or more secondary memory units to augment a primary memory unit for nodes 102 and 104. Data is transferred between the main memory unit and the secondary memory units when needed in accordance with a replacement algorithm. If the data swapped is designated as a fixed size, the swapping may be referred to as paging. If variable sizes are permitted and the data is split along logical lines such as subroutines or matrices, the swapping may be referred to as segmentation.

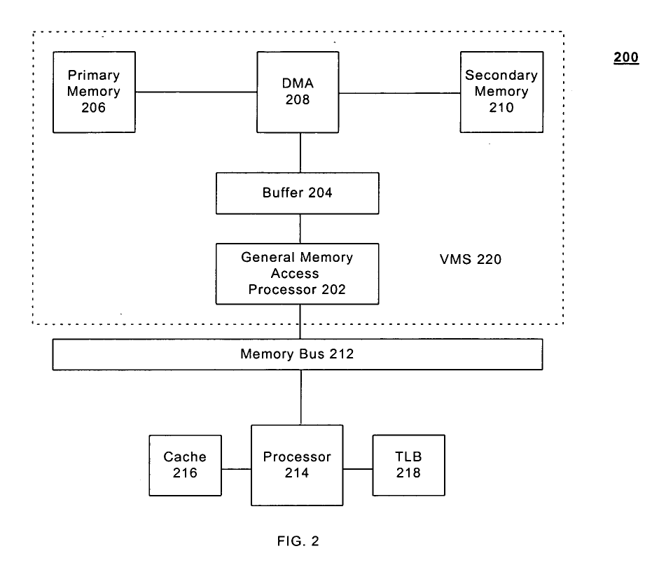

In general operation, an application program may generate a logical address consisting of a logical page number plus the location within that page. VMS 106 and 108 may receive the logical address, and translate the logical address into an appropriate physical address. If the page is present in the main memory, the physical page frame number may be substituted for the logical page number. If the page is not present in the main memory, a page fault occurs and VMS 106 and 108 may retrieve the physical page frame from one of the secondary memory units and write the physical page frame into the main memory. System 100 in general, and VMS 106 and 108 in particular, may be described in more detail with reference to FIGS. 2-4.

FIG. 2 illustrates a block diagram of a system 200. System 200 may be representative of, for example, one or more systems or components of nodes 106 and/or node 108 as described with reference to FIG. 1. As shown in FIG. 2, system 200 may comprise a plurality of elements, such as a processor 214, a cache 216 and a translation lookaside buffer (TLB) 218, all connected to a VMS 200 via a memory bus 212. Although FIG. 2 shows a limited number of elements, it can be appreciated that any number of additional elements may be used in system 200.

In one embodiment, system 200 may include processor 214. Processor 214 can be any type of processor capable of providing the speed and functionality desired for a given implementation. For example, processor 214 could be a processor made by Intel® Corporation and others. Processor 214 may also comprise a digital signal processor (DSP) and accompanying architecture. Processor 214 may further comprise a dedicated processor such as a network processor, embedded processor, micro-controller, controller and so forth. The embodiments are not limited in this context.

In one embodiment, system 200 may include cache 216. Cache 216 may be an L1 or L2 cache, for example. Cache 216 is typically smaller than primary memory unit 206 and secondary memory unit 210, but can be accessed faster than either memory unit. This is because cache 216 is typically located on the same chip or die as processor 214, or may consist of a memory unit having lower latency, such as static random access memory (SRAM), for example. Consequently, when processor 214 needs data, processor 214 first attempts to determine whether the data is stored in cache 216 before searching primary memory unit 206 and/or secondary memory unit 210.

In one embodiment, system 200 may include TLB 218. When a process executing within processor 214 requires data, the process will specify the required data using a virtual address. TLB 218 may perform virtual address to physical address translation information for a small set of recently, or frequently, used virtual addresses. TLB 218 may be implemented in hardware, software, or a combination of both, depending on the design constraints for a given implementation. When implemented in hardware, for example, TLB 218 can quickly provide processor 214 with a physical address translation of a requested virtual address. TLB 218 may contain, however, translations for only a limited set of virtual addresses. Additional translations may be found using additional TLB attached to processor 214, or a table storage buffer (TSB) stored in primary memory unit 206. The embodiments are not limited in this context.

In one embodiment, system 200 may include VMS 220. VMS 220 may be representative of, for example, VMS 106 and/or 108 described with reference to FIG. 1. As shown in FIG. 2, VMS 220 may include a general memory access processor (GMAP) 202, a buffer 204, a primary memory unit 206, a direct memory access (DMA) controller 208, and a secondary memory unit 210. It may be appreciated that VMS 220 may comprise additional virtual memory elements. The embodiments are not limited in this context.

In general, VMS 220 attempts to increase the level of integration between the various memory units available to a processing system in a wireless device, such as nodes 102 and 104. For example, VMS 220 attempts to integrate the higher speed volatile memory typically used for main memory in a processing system with the lower speed non-volatile memory typically used as a disk-drive or filing system. The higher level of integration may reduce the overall latency and power requirements associated with accessing memory in a node, particularly for a node using virtual memory techniques such as a paged memory management system. VMS 220 attempts to take advantage of the continuing trend for flash memory to obscure the underlying technology used for the memory cells and control thereof with a higher-level interface abstraction. VMS 220 may be implemented to leverage integration at the die level, integration at the package level, or integration at the board level, with varying impacts to performance, power and cost efficiencies.

VMS 220 may attempt to enhance virtual memory techniques in a number of different ways. For example, VMS 220 may comprise an extension of filing system abstraction to account for primary memory unit 206 behind the abstraction interface, such as page movement commands and low latency access to primary memory unit 206. VMS 220 may also move some of the logic for virtual memory management operations closer to the actual memory components. This may reduce the processing load for processor 214. VMS 220 may also provide a relatively tight coupling of primary memory unit 206 and secondary memory unit 210. This may reduce latency associated with memory access, even as pages are being swapped in and out of primary memory unit 206, for example. VMS 220 may perform background data movement between primary memory unit 206 and secondary memory unit 210 to enable coherency with little or no performance penalties. The background data movement may also enable page pre-fetching for improved performance. VMS 220 may also leverage primary memory unit 206 space for secondary memory unit 210 flash buffers in order to reduce flash die costs. The flash buffers may be used for obfuscating flash write times, coalescing valid data elements from many flash blocks into a smaller space, error management, and so forth. VMS 220 may also provide techniques where the physically addressable memory is accessible by the program addressable memory in a manner that is transparent as to whether the contents are in primary memory unit 206, secondary memory unit 210, and/or buffer 204, for example.

VMS 220 may provide several advantages as a result of these and other enhancements. For example, VMS 220 may reduce page miss latency times due to the more direct access to secondary memory unit 210 by processor 214. In another example, coherency between primary memory unit 206 and secondary memory unit 210 may be handled as a background task, and therefore may not provide additional latency prior to memory access. In yet another example, tight coupling of primary memory unit 206 and secondary memory unit 210 may enable more cost-effective implementations, especially when considering the buffering required for secondary memory unit 210 when implemented using flash memory. In still another example, VMS 220 may offload some of the virtual memory management operations from processor 214 thereby releasing processing cycles for use by other components of system 100 or system 200.

In one embodiment, VMS 220 may include primary memory unit 206. Primary memory unit 206 may comprise main memory for a processing system. Main memory typically comprises volatile memory units operating at higher memory access speeds relative to non-volatile memory units, such as secondary memory unit 210. Primary memory unit 206, however, is typically smaller than secondary memory unit 210, and can therefore store less data. Examples of primary memory unit 206 may include machine-readable media such as RAM, SRAM, dynamic RAM (DRAM), synchronous DRAM (SDRAM), and so forth. The embodiments are not limited in this context.

In one embodiment, VMS 220 may include secondary memory unit 210. Secondary memory unit 210 may comprise secondary memory for a processing system. Secondary memory typically comprises non-volatile memory units operating at lower memory access speeds relative to volatile memory units, such as primary memory unit 206. Secondary memory unit 210, however, is typically larger than primary memory unit 206, and can therefore store more data. Examples of secondary memory unit 210 may include machine-readable media such as flash memory, magnetic disk (e.g., floppy disk and hard drive), optical disk (e.g., CD-ROM), and so forth. The embodiments are not limited in this context.

In one embodiment, VMS 220 uses virtual memory techniques to take advantage of the higher access speeds provided by primary memory unit 206 in combination with the larger amount of memory provided by secondary memory unit 210. For example, secondary memory unit 210 may be divided into pages. The pages may be swapped in and out of primary memory unit 206 as they are needed by processor 214. In this way, processor 214 can access more memory than is available in primary memory unit 206 at a speed that is roughly the same as if all of the memory in secondary memory unit 210 could be accessed with the speed of primary memory unit 206.

In one embodiment, VMS 220 may include DMA 208. DMA 208 may comprise a DMA controller and accompanying architecture, such as various First-In-First-Out (FIFO) buffers. DMA 208 may perform direct memory transfers of information between primary memory unit 206 and secondary memory unit 210. DMA 208 may perform such transfers in response to control information provided by GMAP 202 and/or processor 214.

In one embodiment, VMS 220 may include buffer 204. Buffer 204 may comprise one or more hardware buffers, such as FIFO buffer, Last-In-First-Out (LIFO) buffer, registers, and so forth. Buffer 204 may be used to temporarily store information as it is transferred between primary memory unit 206 and secondary memory unit 210. Buffer 204 may also be used to temporarily store information as it is transferred between processor 214 and VMS 220 via memory bus 212.

In one embodiment, VMS 220 may include GMAP 202. GMAP 202 may connect to primary memory unit 206 and secondary memory unit 210. GMAP 202 may perform virtual memory management operations for processor 214 using primary memory unit 206 and secondary memory unit 210. Examples of virtual memory management operations may include translating virtual addresses to physical addresses, retrieving information in response to requests by processor 214, transferring information between primary memory unit 206 and secondary memory unit 210, maintaining coherency between copies of information stored in primary memory unit 206 and secondary memory unit 210, and so forth. The embodiments are not limited in this context.

In one embodiment, GMAP 202 may receive commands for accessing primary memory unit 206. GMAP 202 may also have additional commands for manipulating pages for demand paging operations. By moving some of the demand paging operations to GMAP 202, certain optimizations can be made to VMS 220 which may take into account the buffer sizes on secondary memory unit 210, such as whether to write an entire old page back to secondary memory unit 210 prior to writing a new page to primary memory unit 206 or some subset. In addition, GMAP 202 may reduce latency in accessing data that is on the page being swapped into primary memory unit 206. For example, the requested data can be sent to processor 414 directly from secondary memory unit 210 prior to having the requested data placed in primary memory unit 206.

In one embodiment, GMAP 202 could be located in the same silicon with secondary memory unit 210, since GMAP 202 may then have access to the buffers in secondary memory unit 210. Alternatively, GMAP 202 may be placed on the same die as processor 214. It is worthy to note that GMAP 202 does not necessarily eliminate the possibility of having other masters on interfaces for primary memory unit 206 and secondary memory unit 210. In any event, GMAP 202 should be implemented in a manner that does not add any latency to accessing primary memory unit 206. For example, any checking of page status during the swapping of pages should be checked in parallel, and if the data is retrieved from secondary memory unit 210, the data should be returned to processor 214 as if it had come from primary memory unit 206.

In one embodiment, GMAP 202 may be able to track new writes to primary memory unit 206. In this manner, GMAP 202 may be able to, in parallel, update secondary memory unit 210 to ensure coherency. This may reduce the need for page writes back to secondary memory unit 210 during page swapping, or prior to shutdown. This may also extend battery life for a wireless device, since entire pages are not being written back to secondary memory unit 210, but rather only the data that has changed. Different partitions for secondary memory unit 210 may be needed to take advantage of this technique.

In one embodiment, GMAP 202 may perform virtual memory management operations for VMS 220. For example, GMAP 202 may be connected to various memory units for a processing system, such as buffer 204, primary memory 206, and secondary memory 210. GMAP 202 may be arranged to receive a request for data from processor 214, and determine where the data is currently stored among the various memory units. GMAP 202 may then attempt to provide the requested data from one of the various memory units to processor 214 in a manner that reduces latency in responding to the request. GMAP 202 may also control page transfer operations for transferring pages between primary memory unit 206 and secondary memory 210. GMAP 202 may program DMA 208 to perform such page transfers. GMAP 202 may also move some of the page transfer operations to background processes in order to further reduce latency in fulfilling data requests by processor 214.

In one embodiment, for example, GMAP 202 may receive a first request by processor 214 for information stored in a first page. GMAP 202 may determine whether the first page is stored in primary memory unit 206. If the first page is not stored in primary memory unit 206, GMAP 202 may retrieve the first page from secondary memory unit 210. GMAP 202 may retrieve the information from the first page, and send the retrieved information to processor 214 in response to the first request.

In one embodiment, GMAP 202 may perform demand paging between primary memory unit 206 and secondary memory unit 210 using DMA 208. Demand paging means pages may be swapped in and out of primary memory unit 206 as they are needed by active processes. When a non-resident page is needed by a process, a decision must be made as to which resident page is to be replaced by the requested page. This decision may be made in accordance with a page replacement policy. A page replacement policy attempts to select a resident page that will not be referenced again by a process for a relatively long period of time. Examples of page replacement policies can include a FIFO policy, least recently used (LRU) policy, LIFO policy, least frequently used (LFU) policy, and so forth. The replacement policy is typically implemented by processor 214 under instructions from an operating system. Alternatively, GMAP 202 may be arranged to select page replacement in accordance with a given page replacement policy. The embodiments are not limited in this context.

Operations for systems 100 and 200 may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

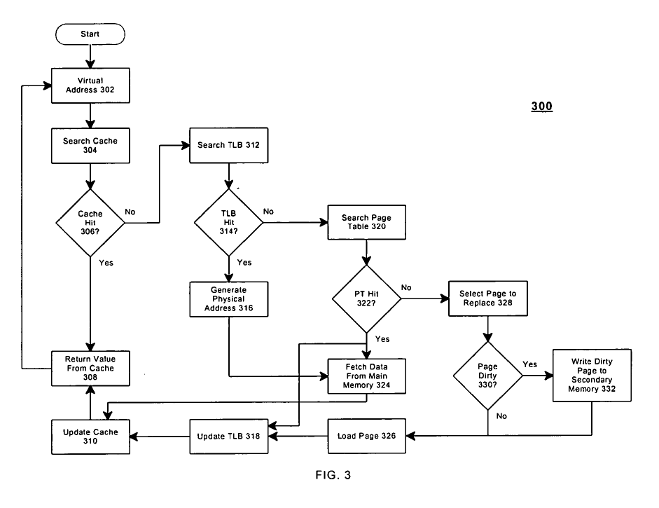

FIG. 3 illustrates a programming logic 300. FIG. 3 illustrates a programming logic 300 that may be representative of the operations executed by one or more systems described herein, such as system 100 and/or system 200. As shown in programming logic 300, an application program may be executed by processor 214. The application program may instruct processor 214 to retrieve information such as instructions or data using a virtual address at block 302. The virtual address may include a logical page number plus the location of the information within the logical page. Processor 214 may first search cache 216 for the requested information at block 304.

A determination may be made as to whether the requested information is in cache 216 at block 306. If the requested information is available in cache 216, then the requested information may be returned from cache 216 to processor 214 at block 308. If the requested information is not available in cache 216 at block 306, however, program control may be passed to block 312. At block 312, TLB 218 may be searched for a translation of the virtual address to a physical address.

A determination may be made as to whether a translation is available in TLB 218 (“TLB Hit”) at block 314. If there is a TLB Hit at block 314, a physical address may be generated for the virtual address at block 316. The requested information may be retrieved from primary memory unit 206 at block 324. Cache 216 may be updated with the requested information at block 310. The requested information may be retrieved from cache 216 at block 308, and passed to processor 214. If there is no translation available in TLB 218 (“TLB Miss”), however, program control may be passed to block 320.

When there is a TLB Miss at block 314, a page table may be searched at block 320. Each address space within a system has associated with it a page table and a disk map. These two tables may describe an entire physical address space. The page table may identify which pages are in primary memory unit 206, and in which page frames those pages are located. The disk map may identify where all the pages are in secondary memory unit 210. The entire address space is in secondary memory unit 210, but only a subset of the address space is resident in primary memory unit 206 at any given point in time. The page table may contain a Page Table Entry (PTE) for each virtual memory page. Each PTE may contain a pointer to the physical address of the corresponding virtual memory page as well as means for designating whether the page is available, such as a valid bit. If the page referenced in the PTE is currently available, then the valid bit is typically set to one. If the page is not available, then the valid bit is typically set to zero.

A determination may be made as to whether the requested page is available at block 322. If the PTE for the requested page indicates that the requested page is available in primary memory unit 206 (“PT Hit”) at block 322, then the requested information may be retrieved from primary memory unit 206 at block 324. TLB 218 may also be updated with the translation information from the page table at block 318. Cache 216 may be updated with the requested information at block 310. The requested information may be retrieved from cache 216 at block 308, and passed to processor 214. If the PTE for the requested page indicates that the requested page is not available in primary memory unit 206 (“PT Miss”), then processor 214 or GMAP 202 may select a page to be replaced or swapped out of primary memory unit 206 in accordance with a page replacement policy at block 328.

Once a resident page has been selected for replacement, GMAP 202 may determine whether the page has been modified prior to replacing the resident page with a non-resident page at block 330. The PTE for each virtual memory page may also include a status bit to indicate whether the selected page has been modified while in primary memory unit 206. A modified page may sometimes be referred to as a “dirty page.” If the selected page has been determined to be dirty at block 330, the selected page may be written to secondary memory unit 210 at block 332, and then the non-resident page may be loaded into primary memory unit 206 to replace the selected page at block 326. If the selected page is not dirty, however, then control may be passed directly to block 326. TLB 218 may be updated with the translation information from the page table at block 318. Cache 216 may be updated with the requested information at block 310. The requested information may be retrieved from cache 216 at block 308, and passed to processor 214.

It may be appreciated that several variations may be made to programming logic 300 and still fall within the scope of the embodiments. For example, TLB 218 may also be updated with the translation information from the page table at block 318 immediately after a page has been selected for replacement at block 328, rather than after loading the replacement page at block 326. This may be desirable since TLB 218 will be updated for use by processor 214 thereby removing further memory access latency. The embodiments are not limited in this context.

In one embodiment, programming logic 300 may provide an example of some of the events within the memory hierarchy in a demand paged system, such as a wireless device executing Windows® operating system made by Microsoft® Corporation, for example. As shown in FIG. 3, when a PT Miss occurs, a new page must be loaded into primary memory unit 206 from secondary memory unit 210. In some cases this new page is replacing an old page. The decisions regarding which page to replace is typically made by the operating system, but high-level commands could be used to push many of the details of page replacement closer to the memory units via GMAP 202, thereby enabling potential for lower latency accesses to the data during these operations. Many of the transfer operations may be performed using a DMA, such as DMA 208. Programming logic 300 may extend DMA capability to include fetching the requested data that causes a PT Miss earlier within the sequence of virtual memory management operations.

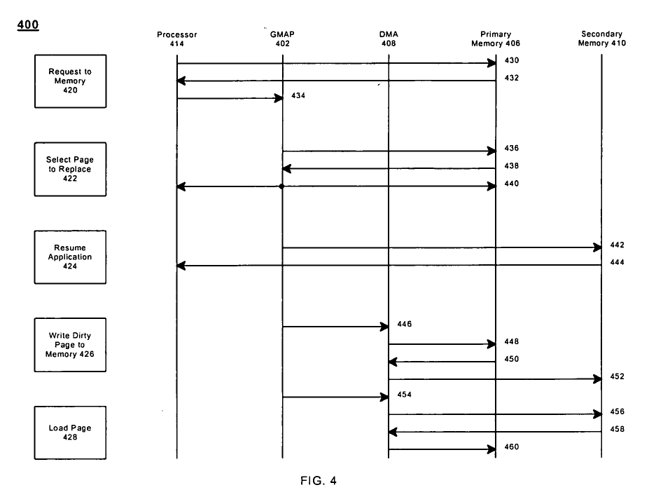

FIG. 4 illustrates a message flow diagram 400. The operation of the above described systems and associated programming logic may be better understood by way of example. Message flow diagram 400 provides an example implementation of the messages sent between processor 414, GMAP 402, DMA 408, primary memory unit 406, and secondary memory unit 410. In one embodiment, elements 414, 402, 408, 406 and 410 as described with reference to FIG. 4 may be similar to corresponding elements 214, 202, 208, 206 and 210 as described with reference to FIG. 2. The embodiments are not limited in this context.

As shown in message flow diagram 400, various virtual memory management operations may be performed by VMS 220. For example, processor 214 may send a request to memory that causes a TLB Miss and PT Miss at block 420. Processor 414 may send a message 430 to primary memory unit 406 to request page table lookup data. Primary memory unit 406 may send a message 432 to processor 414 with the page table lookup data. Processor 414 may send a message 434 to GMAP 402 with a request for data and page replacement. It is worthy to note that GMAP 402 may be implemented such that there is little or no latency penalty introduced when processor 414 attempts to access primary memory unit 406.

In one embodiment, GMAP 402 may perform page selection in accordance with a page replacement policy at block 422. For example, GMAP 402 may send a message 436 to primary memory unit 406 in response to message 434 received from processor 414. Message 436 may request page table data and/or access statistics from primary memory unit 406. Primary memory unit 406 may send message 438 to GMAP 402 with the page table data and/or access statistics. GMAP 402 may then send message 440 to primary memory unit 406 to update the page table, and also to processor 414 to inform processor 414 of the page table updates.

In one embodiment, execution of the application program by processor 414 may resume as the requested information which caused a TLB Miss and PT Miss is sent to processor 414 from secondary memory unit 410 at block 424. For example, GMAP 402 may send a message 442 to secondary memory unit 410 for the requested information. Secondary memory unit 410 may send message 444 with the requested information to GMAP 402, which forwards the requested information to processor 414.

In one embodiment, various virtual memory management operations for demand paging may be performed at blocks 426 and 428 after the requested information has been delivered to processor 414. In this manner, VMS 220 may fulfill requests by processor 414 in a manner that reduces latency relative to conventional techniques.

In one embodiment, for example, GMAP 402 may determine whether the selected page is dirty at block 426. If the selected page is dirty at block 426, then GMAP 402 may send a message 446 to DMA 408 to program DMA 408 for a dirty page write. DMA 408 may send a message 448 to primary memory unit 406 to request the dirty page data. Primary memory unit 406 may send a message 450 to DMA 408 with the dirty page data. DMA 408 may send a message 452 to secondary memory unit 410 to write the dirty page data to secondary memory unit 410.

In one embodiment, for example, GMAP 402 may load a replacement page at block 428. GMAP 42 may send a message 454 to DMA 408 to program DMA 408 for a new page load. DMA 408 may send a message 456 to secondary memory unit 410 to request the new page data. Secondary memory unit 410 may send a message 458 with the new page data. DMA 408 may send a message 460 to primary memory unit 406 to write the new page data to primary memory unit 406.

As shown in message flow 400, the data request that originally caused the TLB Miss and PT Miss is returned to processor 414 earlier in the virtual memory sequence, and thus enables the application program to resume. Since the page load is occurring in the background, future accesses may not incur any delay due to a TLB Miss or PT Miss. GMAP 402 may track whether or not the access should go to primary memory unit 406 or back to secondary memory unit 410, depending on whether or not that part of the page has been loaded.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

All or portions of an embodiment may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a processor. In another example, an embodiment may be implemented as dedicated hardware, such as a circuit, an application specific integrated circuit (ASIC), Programmable Logic Device (PLD) or DSP, and so forth. In yet another example, an embodiment may be implemented by any combination of programmed general-purpose computer components and custom hardware components. The embodiments are not limited in this context.

1. A system, comprising:
an antenna;
a transceiver to couple to said antenna;
a processor to couple to said transceiver; and
a virtual memory system to couple with said processor, said virtual memory system comprising:
a primary memory unit;
a secondary memory unit; and
a general memory access processor to couple to said primary memory unit and said secondary memory unit, said general memory access processor to control virtual memory management operations for said processor using said primary memory unit and said secondary memory unit in response to requests for information received from said processor.

2. The system of claim 1, further comprising a direct memory access controller to couple said primary memory unit with said secondary memory unit, said direct memory access controller to transfer information between said primary and secondary memory units in response to control signals from said general memory access processor.

3. The system of claim 1, further comprising a buffer to store information communicated between said memory units, and between said memory units and said general memory access processor.

4. The system of claim 1, wherein said primary memory unit comprises random access memory and said secondary memory unit comprises flash memory.

5. The system of claim 1, wherein said general memory access processor receives a request for data from a page of information, determines whether said page is in one of said primary memory unit, said secondary memory unit, and said buffer, and retrieves said data from said page of information in accordance with said determination.

6. An apparatus, comprising:
a primary memory unit;
a secondary memory unit; and
a general memory access processor to couple to said primary memory unit and said secondary memory unit, said general memory access processor to perform virtual memory management operations for a processor using said primary memory unit and said secondary memory unit.

7. The apparatus of claim 6, further comprising a direct memory access controller to couple said primary memory unit with said secondary memory unit, said direct memory access controller to transfer information between said primary and secondary memory units in response to control signals from said general memory access processor.

8. The apparatus of claim 6, further comprising a buffer to store information communicated between said memory units, and between said memory units and said general memory access processor.

9. The apparatus of claim 6, wherein said primary memory unit comprises random access memory and said secondary memory unit comprises flash memory, with said processor to access said primary memory unit and said secondary memory unit via said general memory access processor.

10. The apparatus of claim 9, wherein said general memory access processor is integrated with said flash memory.

11. The apparatus of claim 6, wherein said general memory access processor is external to a memory controller.

12. The apparatus of claim 6, wherein said general memory access processor receives a request for a data from a page of information, determines whether said page is in one of said primary memory unit, said secondary memory unit, and said buffer, and retrieves said data from said page of information in accordance with said determination.

13. A method, comprising:
receiving a first request by a processor for information stored in a first page;
determining whether said first page is stored in a primary memory unit;
retrieving said first page from a secondary memory unit if said first page is not stored in said primary memory unit;
retrieving said information from said first page; and
sending said retrieved information to said processor in response to said first request.

14. The method of claim 13, further comprising:
selecting a second page stored in said primary memory unit;
determining whether said second page has been modified;
sending a second request for said modified second page to said primary memory unit;
receiving said modified second page from said primary memory unit; and
writing said modified second page to said secondary memory unit.

15. The method of claim 14, further comprising:
sending a third request for said first page to said secondary memory unit;
receiving said first page from said secondary memory unit; and
writing said first page to said primary memory unit to replace said second page.

16. The method of claim 14, wherein said selecting comprises receiving a page number for said second page from said processor.

17. The method of claim 16, wherein said selecting further comprises:
sending a fourth request for page table data to said primary memory unit;
receiving said page table data from said primary memory unit;
updating a page table with said page table data; and
sending said updated page table to said processor.

18. An article comprising:
a storage medium;
said storage medium including stored instructions that, when executed by a processor, are operable to receive a first request by a processor for information stored in a first page, determine whether said first page is stored in a primary memory unit, retrieve said first page from a secondary memory unit if said first page is not stored in said primary memory unit, retrieve said information from said first page, and send said retrieved information to said processor in response to said first request.

19. The article of claim 18, wherein the stored instructions, when executed by a processor, are further operable to select a second page stored in said primary memory unit, determine whether said second page has been modified, send a second request for said modified second page to said primary memory unit, receive said modified second page from said primary memory unit, and write said modified second page to said secondary memory unit.

20. The article of claim 19, wherein the stored instructions, when executed by a processor, are further operable to send a third request for said first page to said secondary memory unit, receive said first page from said secondary memory unit, and write said first page to said primary memory unit to replace said second page.

21. The article of claim 19, wherein the stored instructions, when executed by a processor, perform said selecting by using stored instructions operable to receive a page number for said second page from said processor.

22. The article of claim 21, wherein the stored instructions, when executed by a processor, perform said selecting by using stored instructions operable to send a fourth request for page table data to said primary memory unit, receive said page table data from said primary memory unit, update a page table with said page table data, and send said updated page table to said processor.
